(19) United States
(12) Patent Application Publication
(10) Pub. No.: US 2020/0015187 A1
(43) Pub. Date: Jan. 9, 2020

(54) Location Determination of Fixed/Portable Devices

(71) Applicant: Microsoft Technology Licensing, LLC, Redmond, WA (US)

(72) Inventor: Amer A. Hassan, Kirkland, WA (US)

(73) Assignee: Microsoft Technology Licensing, LLC, Redmond (US)

(21) Appl. No.: 16/572,244

(22) Filed: Sep. 16, 2019

Related U.S. Application Data
(62) Division of application No. 15/820,353, filed on Nov. 21, 2017.

(51) Int. Cl. H04W 64/00

(52) U.S. Cl. CPC H04W 64/003; H04W 88/08

(57) ABSTRACT

Techniques for determining locations of one or more access points herein include receiving device location information and signal strength information from a plurality of mobile devices. The device location information indicates a location of a respective one of the plurality of mobile devices, and the signal strength information includes information indicative of a strength of one or more signals from the one or more access points measured by the respective one of the plurality of mobile devices at the location indicated in the device location information. These techniques also include associating the device location information and the signal strength information received from the plurality of mobile devices with a respective one of the one or more access points; and determining a location of the one or more access points of the network based at least on the device location information and signal strength information.

### CROSS-REFERENCE TO RELATED APPLICATION

This application is a divisional of and claims priority under 35 U.S.C. § 120 to U.S. patent application Ser. No. 15/820,353 filed on Nov. 21, 2017 and entitled “Location Determination of Fixed/Portable Devices,” the entirety of which is incorporated by reference herein in its entirety.

### BACKGROUND

The use of Wireless Local Area Networks (WLANs) to implement wireless communications for mobile devices has become common in private and public settings. A network manager typically implements a WLAN by placing access points at locations that provide wireless coverage over a desired area. These access points may include fixed/portable access points. In certain cases, the locations of each of these access points within the WLAN's coverage area may not be accurately known. This may be because of an original inaccurate placement, or because the access points are moved or relocated over time as the WLAN is operated.

### SUMMARY

A server according to a first aspect of the invention includes a processor and a computer-readable medium. The computer-readable medium stores instructions for causing the processor to perform operations that include receiving device location information and signal strength information from a plurality of mobile devices, the device location information indicating a location of a respective one of the plurality of mobile devices, the signal strength information including information indicative of a strength of one or more signals from one or more access points measured by the respective one of the plurality of mobile devices at the location indicated in the device location information; associating the device location information and the signal strength information received from the plurality of mobile devices with a respective one of the one or more access points; and determining a location of the one or more access points of the network based at least on the device location information and signal strength information.

A method, executed by a data processing system for determining locations of one or more access points, according to a second aspect of the invention includes receiving device location information and signal strength information from a plurality of mobile devices, the device location information indicating a location of a respective one of the plurality of mobile devices, the signal strength information including information indicative of a strength of one or more signals from the one or more access points measured by the respective one of the plurality of mobile devices at the location indicated in the device location information; associating via a processor the device location information and the signal strength information received from the plurality of mobile devices with a respective one of the one or more access points; and determining via the processor a location of the one or more access points of the network based at least on the device location information and signal strength information.

A memory device according to a third aspect of the invention stores instructions that, when executed on a processor of a computing device, cause the computing device to determine locations of access points, by receiving device location information and signal strength information from a plurality of mobile devices, the device location information indicating a location of a respective one of the plurality of mobile devices, the signal strength information including information indicative of a strength of one or more signals from the one or more access points measured by the respective one of the plurality of mobile devices at the location indicated in the device location information; associating the device location information and the signal strength information received from the plurality of mobile devices with a respective one of the one or more access points; and determining a location of the one or more access points of the network based at least on the device location information and signal strength information.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a diagram illustrating an example network having devices configured to operate according to an implementation of the disclosure;

FIG. 2 is a diagram illustrating portions of an example access point;

FIG. 3 is a flow diagram illustrating operations performed by an example access point;

FIG. 4 is a diagram illustrating portions of an example mobile device;

FIG. 5 is a flow diagram illustrating operations performed by an example mobile device;

FIG. 6 is a diagram illustrating portions of an example server;

FIG. 7 is a flow diagram illustrating operations performed by an example server;

FIG. 8A is a simplified block diagram showing an example mobile device;

FIG. 8B is a simplified block diagram showing an example access point; and,

FIG. 8C is a simplified block diagram showing an example server.

### DETAILED DESCRIPTION

The system, method and apparatus will now be described by use of example embodiments. The example embodiments are presented in this disclosure for illustrative purposes, and are not intended to be restrictive or limiting on the scope of the disclosure or the claims presented herein.

The embodiments provide technology and techniques that allow the location of one or more access point to be determined using information provided by mobile devices. The embodiments are useful in situations in which the location of an access point in a wireless network may not be known accurately, or may not be determined independently by the access point. These situations may occur often in wireless networks. For example, in most cases, the access points of an organization's Wireless Local Area Network (WLAN) do not have global positioning system (GPS) capability to determine their locations. Further, even if GPS capability is implemented in the access points, the access points may be blocked from receiving GPS signals by the walls and ceilings of the facilities in which they are situated. Also, access points are manually installed inside the facilities of the organization, and even though a network layout planning map showing the locations of the access points may exist for an initial WLAN installation, the map may become outdated. For example, the access points may be moved as the organization's use of the facilities changes and the layouts of the facilities change. Additionally, the access points may not have been placed accurately in their initial planned positions because of obstructions such as furniture, utility equipment, and/or office partitions.

Having only inaccurate location information for access points in a WLAN may be problematic. If the locations of one or more access points of a WLAN are being used to determine the location of a mobile device operating in the WLAN, the accuracy of the mobile device's determined location will be affected by any inaccuracies in the locations of the one or more access points. For example, if a network and/or mobile device are configured to determine the location of a mobile device using triangulation based on the locations of access points, the accuracy of the triangulation will be affected by the inaccuracies in the locations of the access points. These inaccuracies may occur whether the triangulation uses only the access point locations or uses the access point locations in combination with techniques such as assisted GPS (A-GPS). In another example, if the WLAN is configured to use the known location of an access point to determine the general area of a facility in which a mobile device is operating, the accuracy of the determination will be affected by the inaccuracy in the location of the access point. Also, generally, it is advantageous for managers of a WLAN to have accurate locations of all access points in the network available to use for network layout planning and maintenance purposes.

The implementations of the disclosure may be used to advantage in the above described situations. The embodiments utilize location data that is received from mobile devices operating in the coverage area of an access point to determine the location of that access point. The access point does not need GPS capability. The location data received from each mobile device advantageously includes a device location and a quality indication that is associated with the accuracy of the device location. In an environment in which the mobile devices may have varying capability to provide an accurate device location, the quality indications allow a set of the best available device locations to be selected for use in the determination of the location of an access point. The implementations also advantageously utilize processes for updating a determined location of an access point. Updating may be performed by collecting device locations and associated quality indications from mobile devices over time in order to be able to determine an updated location of an access point from large samples of device locations and quality indications. This updating may be performed as mobile devices move into and out of the coverage area of the access point to provide a diverse set of device locations and associated quality indications. The quality indications may be utilized in the updating process to choose a set of the best device locations from the diverse set of device locations to use in each update. This achieves a more accurate determination of the location of an access point as the updating is repeated.

While the implementations disclosed herein are described in relation to examples using WLANs, the implementations have applicability to any type of wireless network/system that utilizes any type of apparatus as an access point to provide a wireless mobile device access to the network/system through a communications interface. As used in this disclosure and the claims, the term access point is used generally, and is meant to include any type of apparatus used as an access point to a network/system, such as Wi-Fi access point, a base station, a micro-base station, a cellular base station, a transmitter station, or any other type of apparatus/device that provides a wireless device access to a network through a communications interface. Additionally, while the implementations disclosed herein are described in relation to examples using Global Positioning System (GPS) or assisted GPS (A-GPS) at a mobile device to determine a device location, in other implementations any other type of positioning system may be used to determine the device location. For example, positioning systems such as the Global Navigation Satellite System (GLONASS), the BeiDou Navigation Satellite System (BDS), the Galileo Satellite positioning system, or a local positioning system may be used at the mobile device to determine the device location.

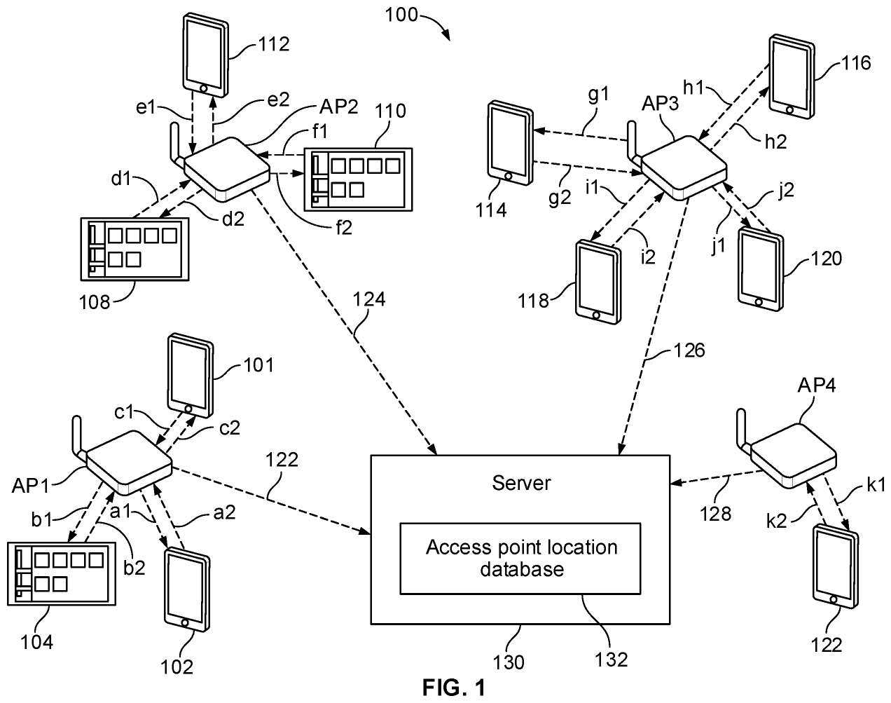

FIG. 1 is a diagram illustrating portions of an example network having devices configured to operate according to an implementation of the disclosure. Network 100 comprises a WLAN that includes access points AP1, AP2, AP3, and AP4, and server 130. Server 130 includes access point location database 132. Mobile devices 102, 104, 106, 108, 110, 112, 114, 116, 118, 120, and 122 may move within the coverage area of network 100 while communicating with server 130 over data links 122, 124, 126, and 128 through access points AP1-AP4, respectively. Data links 122-128 may also provide connections to infrastructure of network 100 for access points AP1-AP4, respectively, that allow mobile devices 102-122 to access a corporate network and/or the internet. Server 130 may be implemented as any type of computing device and may be located in infrastructure of network 100 or be located remotely.

Network 100 may be configured to operate according to one or more of the various IEEE 802 Wi-Fi standards. For example, access points AP1-AP4 and mobile devices 102-122 may operate according to one or more of the IEEE 802.11 Wi-Fi standards. Also, mobile devices 102-122 may be multi-mode devices that are capable of operating in a Wi-Fi mode using Wi-Fi to communicate with network 100, and also capable of operating in a cellular mode using a cellular protocol to communicate with a cellular network. For example, mobile devices 102-122 may operate according to a wide band code division multiple access (WCDMA) cellular system protocol, a long term evolution (LTE) cellular system protocol, a 5G protocol, or any other cellular protocol. Also, each of mobile devices 102-122 may be configured with the capability to determine its own location using GPS or A-GPS. The A-GPS device location procedure may utilize signals and/or data received in cellular mode from cell towers to refine a location determined from GPS satellite signals. The A-GPS determined device location may have a better accuracy than a device location determined using only GPS satellite signals. In other implementations, other types of A-GPS may be used. For example, the A-GPS may utilize signals and/or data received from positioning beacons or accurately located access points to refine a location determined from GPS satellite signals.

In FIG. 1, mobile devices 102, 104, and 106 are in the coverage area of, and are communicating with, access point AP1, mobile devices 108, 110, and 112 are in the coverage area of, and are communicating with, access point AP2, mobile devices 114, 116, 118, and 120 are in the coverage area of, and are communicating with, access point AP3, and, mobile device 122 is in the coverage area of, and is communicating with, access point AP4. Each mobile device communicates with an access point using an uplink and a downlink. For example, mobile device 102 is shown receiving communications from access point AP1 on downlink a1 and sending communications to access point AP1 on uplink a2. In an example configuration of network 100, the uplinks and downlinks used by the mobile devices to communicate with a particular access point may be implemented on shared frequency channels. For example, mobile devices 102, 104, and 106 may each send communications to access point AP1 over uplinks a1, b1, and c1, respectively, over carrier sense multiple access (CSMA) channel at the same frequency, and receive communications from access point AP1 over downlinks a2, b2, and c2, respectively, over a shared data channel at the same frequency. The other access points and mobile devices in system 100 may function similarly.

In other configurations of network 100, the uplink and downlink channels used by different mobile devices to communicate with a particular access point may be implemented on different frequencies. In this case, two mobile devices each communicating with the same access point may send and receive communications on different frequency channels. In other implementations, the mobile devices may communicate with the access points using any assigned frequency channels according to the particular wireless standard that defines the operation of the network.

In an implementation of network 100, the access points AP1-AP4 may be each configured with a location determination application. Also, each of mobile devices 102-122 may be configured with a mobile locator application that interacts with the location determination application. Access points AP1-AP4 and mobile devices 102-122 may operate according to the 802.11 Wi-Fi standard, and the messaging/signaling between the mobile locator applications and location determination applications may be implemented using Wi-Fi action frames. Each access point AP1-AP4 may request and receive location data from one or more of mobile devices 102-122. The location data may include a device location and a quality indication associated with the device location. Each access point AP1-AP4 may then determine its own location based on the mobile device location data it receives. In another example, each of mobile devices 102-122 may be configured to automatically send device location data to the access points AP1-AP4 as the mobile devices 102-122 move throughout network 100. Each access point AP1-AP4 may then utilize the automatically sent device location data received from various mobile devices 102-122 to determine its own location.

The location determination application and the mobile locator application may be installed on each access point and mobile device by a network administrator. For example, network 100 may be a corporate/organizational network in which the access points AP1-AP4, and the mobile devices 102-122, are owned by the corporation/organization. In this case, a network administrator may install the location determination application on each of the access points and the mobile locator application on each mobile device on behalf of the corporation/organization. In another example, network 100 may be a corporate/organizational network in which the access points AP1-AP4 are owned by the corporation/organization, but the mobile devices 102-122 are each owned by private individuals such as employees or students. In this case, a network administrator may install the location determination application on each of the access points, and the owners of the mobile devices may allow the associated mobile locator application to be installed on their mobile devices on a voluntary basis. In a further example, the mobile devices 102-122 of network 100 may comprise a mix of mobile devices in which only some of the mobile devices in network 100 at one time are configured with the mobile locator application capable of communicating with the location determination applications in the access points AP1-AP4. In this case, the location determination applications on the access points AP1-AP4 may be configured to receive capability/compatibility information from the associated mobile locator applications on the mobile devices of mobile devices 102-120 that are equipped with the mobile locator application. For example, the capability/compatibility information may be requested by an access point polling process, or may be received in a registration process when a mobile device first enters the coverage area of an access point. The access points AP1-AP4 then will know which mobile devices 102-120 are available for use in location determination.

In an alternative implementation of network 100, the location determination application may be configured on server 130 rather than on the access points AP1-AP4. In this case, server 130 may receive location data and signal parameters that are associated with one or more of access points AP1-AP4 from one or more of mobile devices 102-122. The location data may include a device location and a quality indication associated with the device location. Server 130 may then determine the location of one or more of the access points AP1-AP4 based on the location data and signal parameters.

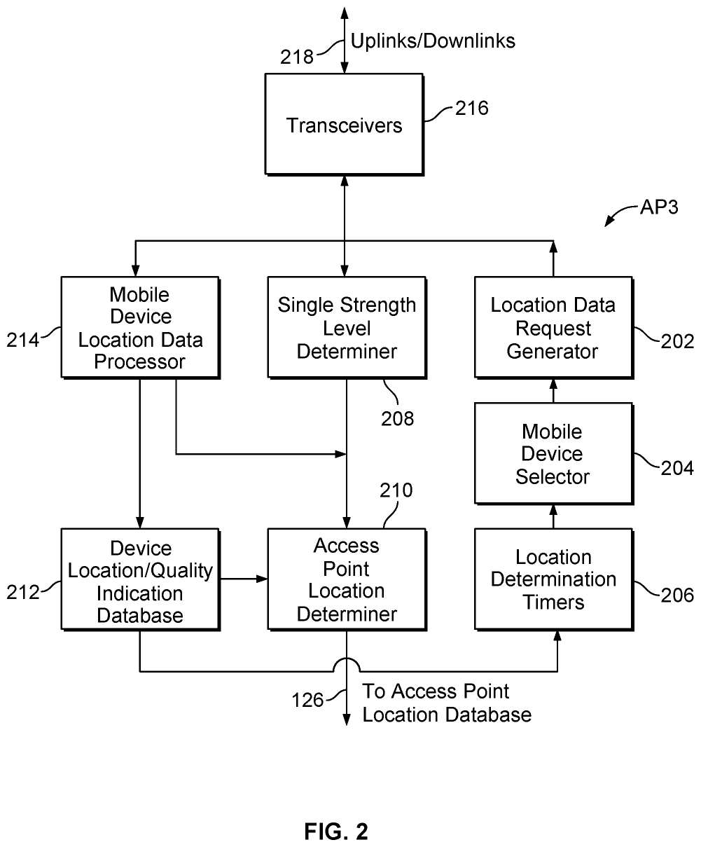

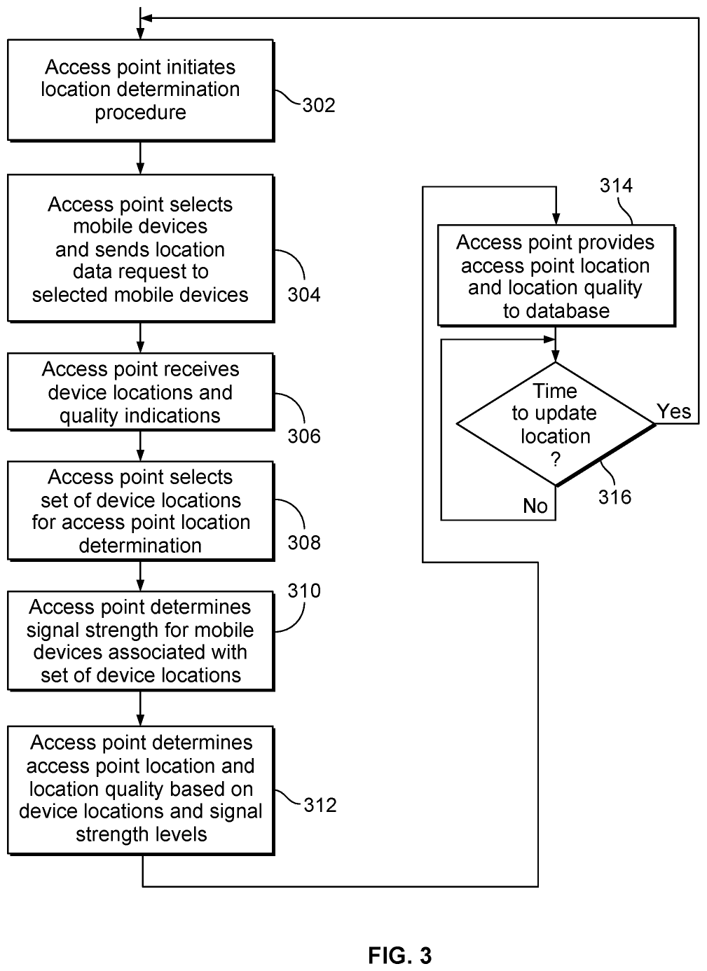

FIG. 2 is a diagram illustrating portions of an example access point. FIG. 2 shows an example configuration of access point AP3. Any of the other access points AP1, AP2, and AP4 shown in network 100 of FIG. 1 may also be configured as shown in FIG. 2. FIG. 2 shows portions of access point AP3 that include mobile device location data processor 214, signal strength level determiner 208, location data request generator 202, mobile device selector 204, location determination timers 206, access point location determiner 210, device location/quality indication database 212, and transceivers 216. Transceivers 216 provide communications with mobile devices over uplinks/downlinks 128. The portions of access point AP3 shown in FIG. 2 may be implemented in any type of hardware (including processors and/or circuitry) or any type of software, or in any combination of hardware and software. One or more of the blocks shown in FIG. 2 may be implemented in a location determination application configured on access point AP3. In operation, access point AP3 operates in conjunction with mobile devices, each configured with an associated mobile locator application that interacts with the portions of access point AP3 shown in FIG. 2. In an implementation, the messaging/signaling between the mobile locator applications and location determination application may be implemented using Wi-Fi action frames. The operations performed by access point AP3 of FIG. 2 will be further described in relation to FIG. 3.

FIG. 3 is a flow diagram illustrating operations performed by an example access point to determine its location. FIG. 3 may be explained using an example of access point AP3 of FIG. 1 and FIG. 2. An example will be given in which each mobile device of mobile devices 114, 116, 118, and 120 operating in the coverage area of access point AP3 in FIG. 1 are configured with a mobile locator application that is compatible with the location determination application configured in access point AP3.

The process begins at 302 where access point AP3 initiates the location determination procedure. The initiation of the location determination procedure may be triggered by an update timer configured in location determination timers 206. The update timer may generate an update trigger signal that causes access point AP3 to initiate the location determination procedure to determine an initial location, or to update a previously determined location. For example, the update timer may be configured to generate the update trigger signal on a periodic basis, such as weekly, or based on a different time period, so that the determined location of access point AP3 is regularly updated. Alternatively, the initiation of the location determination procedure may be triggered at 302 by a network operator initiating the sending of an update trigger signal to access point AP3. This may be done whenever the network operator finds it to be appropriate to update the determined location of access point AP3. In an implementation, the capability of the network operator to trigger the location determination procedure may be implemented in combination with use of the location determination timer 206, so that the location determination may be triggered by either the network operator or the update timer.

At 304, in response to the initiation of the location determination procedure, access point AP3 selects mobile devices and sends location data requests to the selected mobile devices. Mobile device selector 204 may receive the update trigger signal generated at 302 and select mobile devices 114, 116, 118, and 120, in response to the update trigger signal. The selection of mobile devices 114, 116, 118, and 120 may be based on each being configured with the mobile locator application that is compatible with the location determination application in access point AP3. In an implementation, a capabilities registration process or a query/response process may be used by access point AP3 as mobile devices 114, 116, 118, and 120 enter the coverage area of access point AP3 to determine that these devices have the compatible mobile locator application installed. The identities of mobile devices 114, 116, 118, and 120 may then be stored in a database in mobile device selector 204 for use in the selection performed at operation 304.

Mobile device selector 204 provides an indication of the identities of the selected mobile devices 114, 116, 118, and 120 to location request generator 202. In response to receiving the identities from mobile device selector 204, location request generator 202 initiates transmission of a location data request to each of the mobile devices 114, 116, 118, and 120 from transceiver 216 on the appropriate downlinks of uplinks/downlinks 218.

At 306, access point AP3 receives responses to the location data requests sent at 304. The responses include location data for each of the mobile devices 114, 116, 118, and 120. The location data includes a device location and a quality indication associated with the accuracy of the device location. The device location and quality indication may be associated in the access point AP3 with the MAC ID of the mobile device from which it was received. The responses may be received at transceiver 216 on the appropriate uplinks of uplinks/downlinks 218 and provided to mobile device location data processor 214. The device location may be in the form of Global System Positioning System (GPS) coordinates, for example in degrees, minutes, and seconds (DMS) or decimal degrees (DD) format. The quality indication may include an indication of how many GPS satellite signals a mobile device received and used in determining the device location. The quality indication may also include the signal strength of each of the GPS satellite signals used in determining the location. Additionally, the quality indication may also include an indication as to whether the device location was determined using only GPS satellite signals, or whether assisted GPS (A-GPS) was used. The indication of whether GPS or A-GPS was used may be useful because A-GPS determined device locations may have a better accuracy than device locations determined using only GPS satellite signals. In other implementations, the quality indication may include any type of information that can be used to indicate the accuracy of the device location. For example, the quality indication may be in the form of a ranking of the accuracy of the device location such as a high (H), medium (M), or low (L) ranking. In another example, the quality indication may be in the form of a numerical ranking such as a value on a scale of 1 to 10, where 10 is the best device location accuracy and 1 is the worst.

In cases in which a mobile device cannot determine its location, its response to the location data request at 306 may include an indication that the signal strength of GPS signals at that mobile device is inadequate for determining its location, or an indication that there is no GPS signal received at the mobile device.

At 308, access point AP3 selects a set of device locations to be used to determine the location of access point AP3. Mobile device location data processor 214 may include the device locations received at 306 in the selection of the set of device locations. Also, mobile device location data processor 214 may include device locations that were received at 306 from other mobile devices, or any of mobile devices 114, 116, 118, and 120, in previous iterations of the process of FIG. 3 in the selection of the set of device locations. The set of device locations may be selected based on the quality indication associated with each device location. Mobile device location data processor 214 may maintain device location/quality indication database 112 for storing and/or retrieving device locations and quality indications from various iterations of the process. Device location/quality indication database 112 may also include signal strength levels associated with each stored device location and quality indication.

Various considerations may be used at 308 to select the set of device locations to be used to determine the location of access point AP3. For example, in an implementation in which the quality indication includes an indication of the number and signal strength of the GPS satellite signals were used in determining a device location, a set of device locations may be selected based on each device location in the set having been determined using at least a threshold number of GPS satellite signals each having a signal strength of at least a threshold level. In another example, in an implementation in which the quality indication includes an indication as to whether regular GPS or assisted GPS (A-GPS) was used to determining the device location, a set of device locations may be selected based on each device location in the set having been determined using A-GPS. In another example, when the quality indication is in the form of a ranking of the accuracy of the device location, such as a high (H), medium (M), or low (L) ranking, only device locations having a ranking of H may be selected.

At 310, access point AP3 determines an associated signal strength level for each of the set of device locations selected at 308. For example, if set of device locations includes device locations from mobile devices 114, 116, 118, and 120, the signal strength levels would comprises signal strength levels or signals received on the uplinks g1, h1, i1, and j1, from each of mobile devices 114, 116, 118, and 120, respectively. In one implementation, mobile device location data processor 214 may retrieve the signal strength levels from signal level determiner 208, which may include uplink signal strength data for each mobile device communicating with access point AP3, and provide the signal strength levels to access point location determiner 210. If a device location selected for the set of device locations at 308 was stored in device location/quality indication database 212, the signal strength level for that device location may also be retrieved from location/quality indication database 212 and provided to access point location determiner 210.

In an implementation using an alternative to the operation 310 as described above, a signal strength level strength for each of the mobile devices associated with the set of device locations selected at 308 may be measured at the mobile devices instead of at access point AP3. In this implementation, the signal strength level for one or more signals received from access point AP3 at each mobile device may be measured and sent from each of the mobile devices with the location data in the response to the location data request. At 310, the received signal strength levels may then be correlated with the set of device locations selected at 308.

At 312, access point location determiner 210 of access point AP3 determines the location of access point AP3 based on the set of device locations selected at 308 and the signal strengths determined at 310. To determine the location of access point AP3, access point location determiner 210 may determine a distance between access point AP3 and each device location in the set selected at 308 using the signal strength level associated with that device location. Access point location determiner 210 may then use the determined distance from access point AP3 to each device location of the set of device locations, and the location of each device location of the set of device locations to determine the location of access point AP3. For example, access point location determiner 210 may use triangulation techniques to determine the location of access point AP3. At 312, access point location determiner also may determine an access point location quality for the determined location of access point AP3. The access point location quality may be determined based on the quality indications associated with the device locations in the set of device locations that were used in the determination of the location of access point AP3. In an implementation in which the quality indications comprise GPS satellite information, the access point location quality may a ranking based on criteria related to the number and signal strength of the GPS satellite signals that were used in determining the device locations in the set of device locations. In an implementation in which the quality indications comprise rankings, such as high (H), medium (M), or low (L), or a numerical ranking such as a value on a scale of 1 to 10, the access point location quality may be a ranking that is the average of the rankings of quality indications associated with the set of device locations.

At 314, access point location determiner 210 of access point AP3 may communicate the determined location of access point AP3, along with the quality of the determined location, over datalink 126 to access point location database 132 of server 130. From 314 the process moves to 316.

At 316, access point AP3 determines if it is time to update the latest location determined for access point AP3. Access point AP3 may determine if it is time to update the location determination based on an update trigger signal generated by the update timer in location determination timers 206 that was described in relation to 302. The process may wait at 316 until an update trigger signal is received. When an update trigger signal is received, the process moves back to 302 and access point AP3 initiates the location determination procedure to update the location of access point AP3.

In another implementation of access point AP3, the requests for location data that are sent from access point AP3 at 304 may be transmitted by access point AP3 to all mobile devices operating in its coverage area rather than selecting particular mobile devices. The process location determination process will be similar to that described above for FIG. 3, except in this case, the selection of mobile devices may be configured to select all mobile devices operating the coverage area of access point AP3. In this implementation, the update trigger signal may be generated at 302. At 304, location data request generator may receive the update trigger signal and initiate the transmission of a location data request from transceiver 216 to all mobile devices, including mobile devices 114, 116, 118, and 120, operating in the coverage area of access point AP3. At 306, access point AP3 will receive location data from any mobile device of mobile devices 114, 116, 118, and 120 that is configured with the mobile locator application. Operations 308-316 may then be performed as previously described for FIG. 3. Any mobile device operating in the coverage area that is not configured with the mobile locator application will not recognize the location data request sent at 304 and will not respond.

Also, in a further implementation of access point AP3, access point AP3 may be configured to receive and recognize location data sent from mobile devices without access point AP3 needing to send location data requests. In this implementation, access point AP3 may receive location data that includes device locations and quality indications from mobile devices that are configured to automatically send location data to the network 100, recognize the location data as location data for use in determining the location of access point AP3, and process the location data to determine the location of access point AP3. For example, the mobile devices of network 100 may each be configured so that the occurrence of a trigger event at the mobile device automatically triggers the determination and the sending of the location data to the access point having the coverage area in which the mobile device is operating. The trigger event may be timer based or based on an occurrence of certain conditions. In an example of a trigger event, a timer may cause the mobile device to periodically determine and send location data to the access points of network 100 as the mobile device moves within network 100. In another example of a trigger event, when the mobile device determines that it is receiving GPS satellite signals of a number and of a signal strength that provide an accuracy of location determination that is above a threshold for accuracy, the mobile device may determine its location and send location data to the access point having the coverage area in which the mobile device is operating. In this case the mobile device only uses network bandwidth when good location data is available to send. In these implementations, access point AP3 may receive location data from a number of mobile devices over time, as the mobile devices move into and out of the coverage area of access point AP3, and store the location data. In an example, when access point AP3 determines that it has received location data from enough mobile devices having a desired quality level, access point AP3 may update its last determined location with a more accurate location.

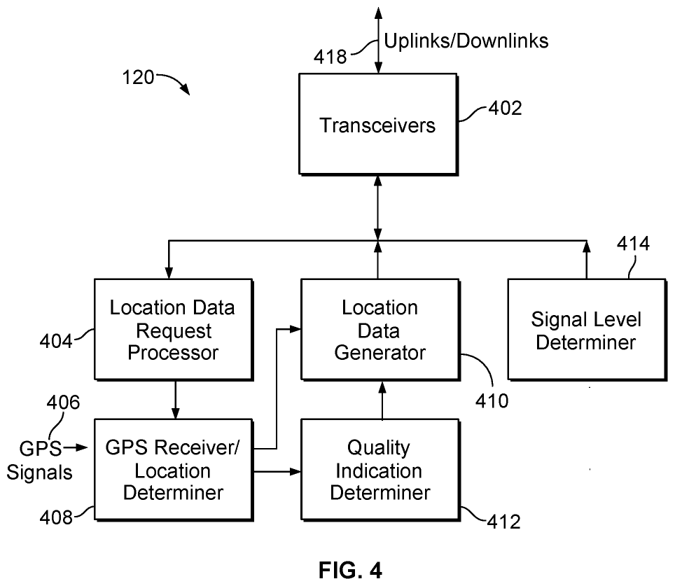

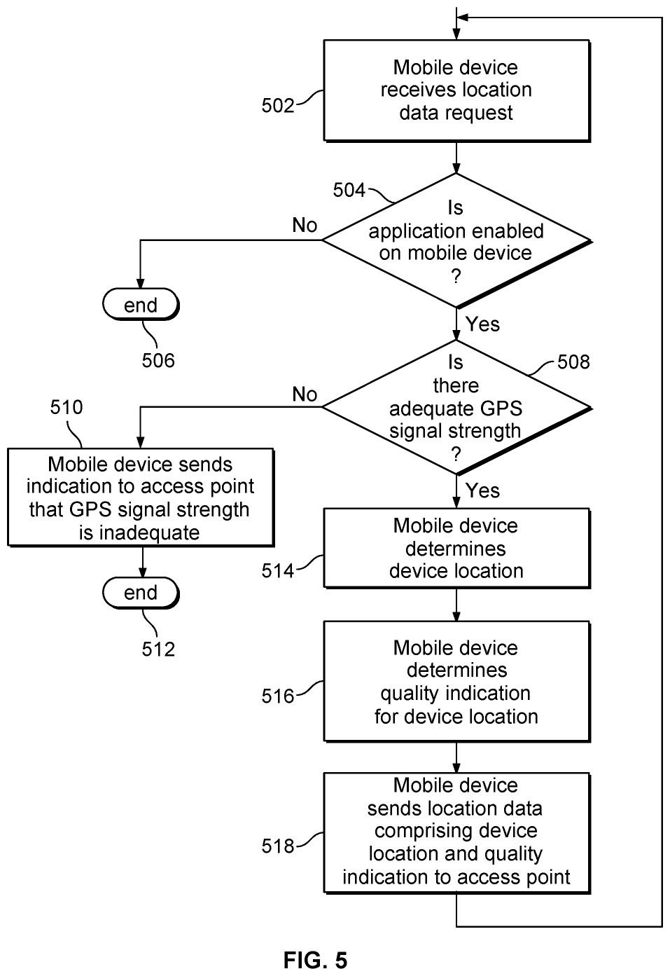

FIG. 4 is a diagram illustrating portions of an example mobile device. FIG. 4 shows an example configuration of mobile device 120 of FIG. 1. Any one of the other mobile devices 102, 104, 106, 108, 110, 112, 114, 116, 118, and 122 shown in network 100 of FIG. 1 may also be configured as shown in FIG. 4. FIG. 4 shows portions of mobile device 120 including location data generator 410, signal strength level determiner 414, quality indication determiner 412, GPS receiver/location determiner 408, and location data request processor 404. The portions of mobile device 120 shown in FIG. 4 may be implemented in any type of hardware, including processors or circuitry, or any type of software, or in any combination of hardware and software. One or more of the blocks shown in FIG. 4 may be implemented in a mobile locator application configured on mobile device 120. In an implementation, mobile device 120 may operate in conjunction with access points, each configured with a location determination application that interacts with the mobile locator application configured on mobile device 120. The mobile locator application controls mobile device 120 to send location data to the access points that allows the access points to determine their locations. The messaging/signaling between the mobile locator application and location determination applications may be implemented using Wi-Fi action frames. In another implementation, mobile device 120 may operate in conjunction with a server configured with a location determination application that interacts with the mobile locator application configured on mobile device 120. The operations performed by mobile device 120 of FIG. 4 will be described further in relation to FIG. 5.

FIG. 5 is a flow diagram illustrating operations performed by an example mobile device according to an implementation. FIG. 5 may be explained using an example of mobile device 120 of FIG. 1 that is configured as shown in FIG. 4. An example will be given in which mobile device 120 is operating in the coverage area of access point AP3 in FIG. 1. In the described example, mobile device 120 is configured with a mobile locator application that is compatible with a location determination application configured in access point AP3. The other mobile devices 102, 104, 106, 108, 110, 112, 114, 116, 118, and 122, and the other access points AP2-AP4, that are shown in FIG. 1, may also function as shown in FIG. 5.

The process begins at 502 where mobile device 120 receives a location data request from access point AP3. The location data request is received by transceiver 402 and provided to location data request processor 404.

At 504 location data request processor 404 determines if the mobile locator application compatible with the location determination application of access point AP3 is enabled. If the mobile locator application is disabled, the process moves to 506 where location data request processor 404 ends the process. If the mobile locator application is enabled, the process moves to 508. Operation 504 may be performed, for example, in an implementation that allows the user of mobile device 102 an option to choose to disable the mobile locator application for privacy purposes.

At 508 location data request processor 404 determines if there is adequate GPS signal strength available to perform location determination. In an implementation GPS receiver/location determiner 408 may provide an indication to location data request processor 404 of the number of signals that GPS receiver/location determiner 408 is currently receiving and is able to decode. If GPS receiver/location determiner 408 is not able to receive and decode enough GPS signals to perform location determination, location data request processor 404 will determine that there is inadequate GPS signal strength for location determination.

If, at 508, location data request processor 404 determines there is inadequate GPS signal strength for location determination, the process moves to 512. At 512, location data request processor 404 provides an indication of inadequate GPS signal strength to location data generator 410 and the process moves to 510. At 510, location data generator 410 initiates transmission of a response from transceiver 402 to access point AP3, where the response indicates that the GPS signal strength at mobile device 120 is inadequate for determining its location. The process then ends at 512. If however, at 508, location data request processor 404 determines that there is adequate GPS signal strength available to perform location determination the process moves to 514.

At 514, mobile device 120 determines its own location (the device location). In an implementation, GPS receiver/location determiner 408 may determine the device location using only GPS satellite signals. In another implementation, GPS receiver/location determiner 408 may determine the device location using GPS satellite signals in combination with an assisted GPS (A-GPS) procedure. When the device location has been determined, GPS receiver/location determiner 408 provides the device location to location data generator 410. The device location may be in the form of GPS coordinates, for example in degrees, minutes, and seconds (DMS) or decimal degrees (DD) format.

At 516, mobile device 120 determines a quality indication for the device location determined at 514. When the device location has been determined at 514, GPS receiver/location determiner 408 may provide data associated with the device location determination to quality indication determiner 412. The data may include an indication of the GPS satellite signals GPS receiver/location determiner 408 received and used when determining the device location. The data may also include the signal strengths of each of the GPS satellite signals that were used. The data may further include an indication of whether the device location determination was performed using only GPS satellite signals, or whether A-GPS was used. In an implementation in which the quality indication comprises GPS satellite information, quality indication determiner 412 may generate the quality indication using the data provide by GPS receiver/location determiner 408 to include information related to the number and signal strength of the GPS satellite signals that were used in determining the device location. In an implementation in which the quality indication comprises a rankings, such as high (H), medium (M), or low (L), or a numerical ranking such as a value on a scale of 1 to 10, quality indication determiner 412 may generate the ranking based on criteria related to the number and signal strength of the GPS satellite signals that were used in determining the device. When quality indication determiner 412 has determined the quality indication, the quality indication is provided to location data generator 410.

At 518, location data generator 410 configures the device location and quality indication into a set of location data and initiates transmission of the location data including the device location and the quality indication to access point AP3 from transceiver 402. The process then returns to 502.

In an alternative implementation of FIG. 5, mobile device 120 may be configured so that the occurrence of a trigger event at mobile device 120 automatically triggers the determination and sending of the location data to the access point having the coverage area in which mobile device 120 is operating. The trigger event may be timer based or may be based on an occurrence of certain conditions. In an example of a trigger event, the trigger event may be the generation of a trigger signal by a timer. In this case, a timer may cause mobile device 120 to periodically determine and send location data to the access points of network 100 by generating a trigger signal as mobile device 120 moves within network 100. In another example of a trigger event, the trigger event may be a determination that the location of the device has been determined with an accuracy that is above a threshold level. In this case, when mobile device 120 determines that it is receiving GPS satellite signals of a number and signal strength that provide an accuracy of location determination that is above a threshold level for accuracy, mobile device 120 may determine its location and send location data to the access point having the coverage area in which the mobile device is operating. This alternative implementation may be used, for example, in conjunction with an implementation of network 100 in which each of access points AP1-AP4 receives and recognizes location data automatically sent from many mobile devices. In this implementation, each of access points AP1-AP4 may build up a data base of location data including device locations and quality indications sent by many different mobile devices over time. The best/highest quality location data in the data base of each access point may then be used to determine an accurate access point location for the access point.

In another implementation of FIG. 5, a signal strength level for one or more signals received from access point AP3 at mobile device 120 may be measured by signal strength level determiner 414, provided to location data generator 410, and sent to access point AP3 with the location data at 518. The signal strength level may be utilized by access point AP3 in determining the location of access point AP3.

Also, in another example implementation, mobile device 120 may be configured to operate in conjunction with server 130, where server 130 is configured with a location determination application that interacts with a mobile locator application configured on mobile device 120. In this case, mobile device 120 would perform a process similar to that of FIG. 5, with the server in the place of the access point, to send location data to server 130 as mobile device 120 operated in the coverage areas of AP1-AP4 of network 100.

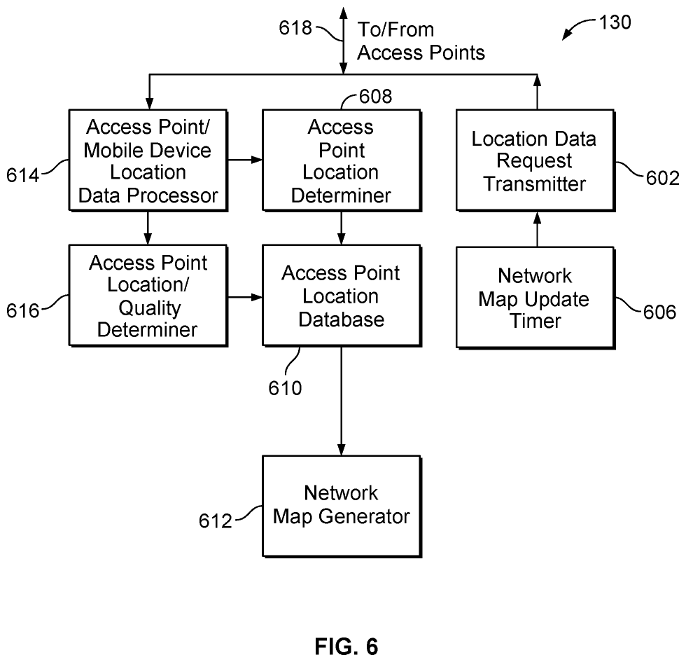

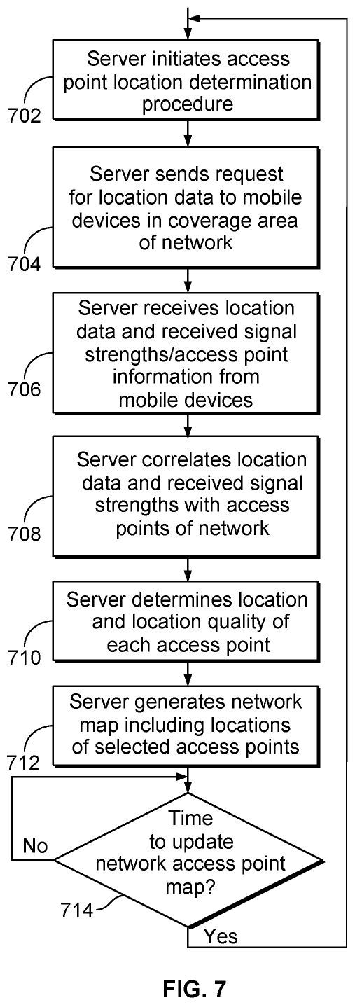

FIG. 6 is a diagram illustrating portions of an example server. FIG. 6 shows an example implementation of server 130 of FIG. 1 that is configured to determine the locations of access points in wireless network 100. Server 130 includes location data request generator 602, network map update timer 606, access point location determiner 608, access point location database 610, network map generator 612, access point/mobile device location data processor 614, and access point location quality determiner 616. Server 130 may communicate with access points AP1-AP4 over datalinks 618. Datalinks 618 may include data links 122, 124, 126, and 128 of FIG. 1. The portions of server 130 shown in FIG. 6 may be implemented in any type of hardware, including processors or circuitry, or any type of software, or in any combination of hardware and software. One or more of the blocks shown in FIG. 6 may be implemented in a location determination application configured on server 130. In an implementation, server 130 may operate in conjunction with a mobile locator application configured on each of the mobile devices 102-122 in network 100. The messaging/signaling between the mobile locator applications and the location determination application may be implemented using Wi-Fi action frames transmit between mobile devices 102-122 and access points AP1-AP4. The operations performed by server 130 of FIG. 6 will be described further in relation to FIG. 7. In an implementation, server 130 may be a cloud based device that is configured to control/manage the location determination function for multiple networks such as network 100.

FIG. 7 is a flow diagram illustrating operations performed by an example server. FIG. 7 may be explained using the example of server 130 of FIG. 1 that is configured as shown in FIG. 6. An example will be given in which each mobile device of mobile devices 102-122 of FIG. 1 is configured with a mobile locator application that is compatible with the location determination application configured in server 130.

The process begins at 702 where server 130 initiates the access point location determination procedure for network 100. The initiation of the access point location determination procedure may be triggered by an update timer configured in network map update timer 606. The update timer generates an update trigger signal that causes server 130 to initiate the location determination procedure. For example, the update timer may be configured to generate the update trigger signal on a periodic basis, such as weekly, or based on a different time period, so that the determined locations of access points AP1-AP4 are regularly updated. Network map update timer 606 may provide the update trigger signal to location data request generator 602. Alternatively, the initiation of the location determination procedure may be triggered at 702 by a network operator sending an update trigger signal to server 130 when the network operator finds it to be appropriate to update the determined location of access points AP1-AP4. In an implementation, the capability of the network operator to trigger the location determination procedure may be implemented in combination with use of the network map update timer 606, so that the location determination procedure may be triggered by either of the network operator or the update timer.

At 704, in response to the initiation of the location determination procedure, server 130 sends request for location data to mobile devices in the coverage area of network 100. Location data request generator 602 may initiate transmission of a location data request to each of mobile devices 102-120 that are configured with the mobile locator application in response to receiving the update trigger signal from network access point location update timer 606. In an implementation, location data request generator 602 may have knowledge that each of mobile devices 102-120 in network 100 is configured with the mobile locator application. For example, a registration process or a query/response process may be used by server 130 as mobile devices operate in the coverage area of network 100 to determine that these devices have the compatible mobile locator application installed. The identities of these mobile devices may then be stored in a database in location data request generator 602. For example, the MAC ID of each of the mobile devices of mobile devices 102-120 may be stored in location data request generator 602. In this example, server 130 may monitor the location of each of the mobile devices as the mobile devices move within network 100 in order to facilitate the sending of the request for location data on data links 618 to each of the mobile devices 102-122 through the appropriate access points of access points AP1-AP4.

At 706, server 130 receives location data and signal strength/access point information from each of the mobile devices 102-120. Access point/mobile device location data processor 614 may receive the location data and signal strength/access point information on data links 618 and provide the location data and signal strength/access point information to access point location determiner 608 and access point location quality determiner 616.

The location data received from each of mobile devices 102-120 at 706 may comprise a device location and a quality indication associated with the device location. The device location may be in the form of GPS coordinates, for example in degrees, minutes, and seconds (DMS) or decimal degrees (DD) format. The quality indication may include an indication of how many GPS satellite signals the mobile device received and used in determining the device location. The quality indication may also include the signal strength of each of the GPS satellite signals used in determining the location. Additionally, the quality indication may also include an indication as to whether the device location was determined using only GPS satellite signals, or whether assisted GPS (A-GPS) was used. Other examples of a quality indication that may be used include any other type of data/information that can be used to indicate the accuracy/reliability of the device location. For example, the quality indication may be in the form of a ranking of the accuracy of the device location such as a high (H), medium (M), or low (L) ranking. In another example, the quality indication may be in the form of a numerical ranking, such as value on a scale of 1 to 10, where 10 is the best device location accuracy and 1 is the worst.

In cases in which a mobile device cannot determine its location, the response to the location data request may include an indication that the signal strength of GPS signals at that mobile device is inadequate for determining its location, or an indication that there is no GPS signal received at the mobile device.

The signal strength/access point information received from mobile devices 102-120 at 706 may comprise a measurement of one or more signals performed at each of the mobile devices 102-120 on signals received from one or more of access points AP1-AP4. For example, the signal strength/access point information from mobile devices 102, 104, and 106 may have been obtained by measuring signals received on uplinks a1, b1, and c1, respectively, from access point AP1, the signal strength/access point information from mobile devices 108, 110, and 112 may have been obtained by measuring signals received on uplinks d1, e1, and f1, respectively, from access point AP2, the signal strength/access point information from mobile devices 114, 116, 118, and 120 may have been obtained by measuring signals received on uplinks g1, h1, i1, and j1, respectively, from access point AP3, and the signal strength/access point information from mobile device 122 may have been obtained by measuring signals received on uplink k1 from access point AP4. The signal strength/access point information received from each of mobile devices 102-120 may also include an identifier of the access point that transmitted the signal from which the signal strength measurement was obtained. In an example, the identifier of the access point may comprise the MAC ID of the access point.

At 708, server 130 correlates the location data and signal strengths/access point information received from each of the mobile devices 102-120 with the access points of network 100. In an implementation, access point location determiner 608 may use the access point MAC ID associated with the signal strength/access point information from a particular mobile device to correlate the access point identified by that MAC ID with that particular mobile device. For example, access point location determiner 608 may correlate mobile devices 102-106 with access point AP1, mobile devices 108-112 with access point AP2, mobile devices 114-120 with access point AP3, and mobile device 122 with access point AP4.

At 710, server 130 determines a location and location quality for each access point from the location data received at 706. Access point location determiner 608 may determine the locations of access points AP1-AP4 using the location data and signal strength received from the mobile devices of mobile devices 102-120 that are correlated with each access point. For example, access point location determiner 608 may determine the distance between access point AP1 and each of mobile devices 102, 104, and 106 based on the signal strength of signals received on the uplinks a1, b1, and c1, respectively. Access point location determiner 608 may then use the determined distances to each of mobile devices 102, 104, and 106 from access point AP1, and the received locations of each of mobile devices 102, 104, and 106, to perform triangulation to determine the location of access point AP1. Access point location determiner 608 may also determine the location of access points AP2 and AP3 in the same manner. In the case of access point AP4, access point location determiner 608 may only make a rough estimation of the location of access point AP4 based on the single set of data received from mobile device 122. Access point location determiner 608 then provides the determined locations of access points AP1-AP4 to access point location database 610. In another implementation, access point location determiner 608 may select a set of the most accurate device locations associated with each access point of AP1-AP4 based on the quality indications associated with the device locations. This may allow a more accurate determination of the location of each access point.

In another implementation of the location determination performed at 710, the location data and received strengths/access point information received at 706 may be combined and/or supplemented with location data and signal strength/access point information received in previous iterations of the process of FIG. 7. In this implementation, server 103 may receive and collect location data and strengths/access point information from multiple iterations of the process performed over time. The multiple iterations of the process may be performed as mobile devices 102-120 and other mobile devices enter, move within, and exit the coverage area of network 100 while sending location data and received strengths/access point information to Server 130. Server 130 may then use the larger data set of the collected location data and signal strength/access point information for more accurate access point location determination. For example, in the scenario shown in FIG. 1, it may be that mobile device 122 sends the only location data and signal strength/access point information that may be correlated with AP4. In this case, server 130 may combine previously collected mobile device location data and signal strengths, which are correlated with access point AP4, with the data received from mobile device 122 to form a set of device locations from which to determine the location of access point AP4. This allows a more accurate determination of the location of access point AP4. In another example using the scenario shown in FIG. 1, it may be that although location data and signal strength/access point information is received from three mobile devices 108, 110, and 112 and correlated with access point AP2, the location data received from mobile device 108 is inaccurate because it was determined using only weak GPS satellite signals. In this case, server 130 may replace the location data received from mobile device 108 with more accurate location data and signal strength information previously received from a different mobile device to form a set of device locations from which to determine the location of access point AP2. Server 130 may then use that more accurate previously received location data and signal strength information in combination with the location data and signal strengths received from mobile devices 110 and 112 to determine a more accurate location of access point AP2.

At 710, in addition to the determination of the locations of access points AP1-AP4 by access point location determiner 608, access point location quality determiner 616 may determine a location quality for each of the determined access point locations. In an implementation, the location quality may comprise an indicator of the relative quality of a determined location. For example, the location quality may be an indicator of a category such as high (H), medium (M), or low (L). The categories may be defined based on parameters such as the number of mobile devices that provided the location data used to determine an access point location, the average number of satellite signals used per mobile device to determine the access point location, and/or the average signal strengths of the GPS satellite signals used per mobile device to determine the access point location. In an implementation in which each of the mobile devices sending location data at 706 send the location quality indications in the form of rankings/categories such as high (H), medium (M), or low (L), or a numerical ranking, the determined location of an access point may then be assigned a location quality that is an average of the rankings of the mobile devices used to determine the access point location. Also, another factor that may be considered in the determination of the location quality at 710 may be whether A-GPS or regular GPS was used by one or more mobile devices in the determination of the access point location. Access point location quality determiner 616 then provides the location quality for each of the determined locations of access points AP1-AP4 to access point location database 610.

At 712, server 130 generates a network map of network 100 that includes the determined locations of access points AP1-AP4. In an implementation, access point location database 610 may provide the most recently determined locations and the associated location quality for each of access points AP1-AP4 to network map generator 612 and network map generator 612 may generate the network map. The network map may be generated, for example, in the form of a data table or in the form of an actual map that shows the layout of the facilities in which network 100 is configured, and the location of access points AP1-AP4 within the facilities. The location quality of each access point location may also be shown on the map. The network map may then be used by a network administrator for management/maintenance of network 100.

From 712, the process moves to 714. At 714, server 130 determines if it is time to update the network map. Server 130 may determine if it is time to update the network map by monitoring for an update trigger signal generated by network map update timer 606. If no trigger signal is received from the update timer the server 130 continues to monitor for the update trigger signal at 714. When an update trigger signal is received, the process returns to 702 and server 130 initiates another iteration of the access point location determination procedure.

In an implementation, the access point location database generated in the process of FIG. 7 may be updated by repeating iterations of the process as mobile devices configured with the locator application move throughout the coverage areas of access points AP1-AP4. By combining and/or supplementing the location data and signal strength levels received in a current iteration of the process with the best/highest quality location data and signal strength levels that was received in previous iterations of the process, the accuracy and/or quality level of the access point locations may be improved over time.

Also, in a further implementation of server 130, server 130 may be configured to receive and recognize location data and signal strength/access point information sent from mobile devices without server 130 sending any requests for location data. In this implementation, server 130 may receive location data and signal strength/access point information from mobile devices that are configured to automatically send location data and signal strength/access point information through the network 100 to server 130. For example, each of mobile devices 102-120 of network 100 may each be configured so that the occurrence of a trigger event at the mobile device automatically triggers the determination and sending of the location data and signal strength/access point information to server 130 through the access point having the coverage area in which each mobile device is operating. The trigger event may be timer based or based on an occurrence of certain conditions. In an example of a trigger event, a timer may cause each of mobile devices 102-120 to periodically determine and send location data and signal strength/access point information to server 130 as the mobile devices move within network 100. In another example of a trigger event, when a mobile device of mobile devices 102-120 determines that it is receiving GPS satellite signals of a number and of a signal strength that provides an accuracy of location determination that is above a threshold for accuracy, the mobile device may determine its location and send location data and signal strength/access point information to server 130. In this implementation, server 130 may receive location data and signal strength/access point information from a number of mobile devices, including mobile devices 102-120, over time as the mobile devices move into and out of the coverage area of access points AP1-AP3, and store the location data and signal strength/access point information. Server 130 may use the stored location data and signal strength/access point information to perform updates of the determined locations for access points AP1-AP3. Over time, as more updates are performed using location data and signal strength/access point information from an increasingly larger number of mobile devices, the determined locations for access points AP1-AP4 will be more accurate.

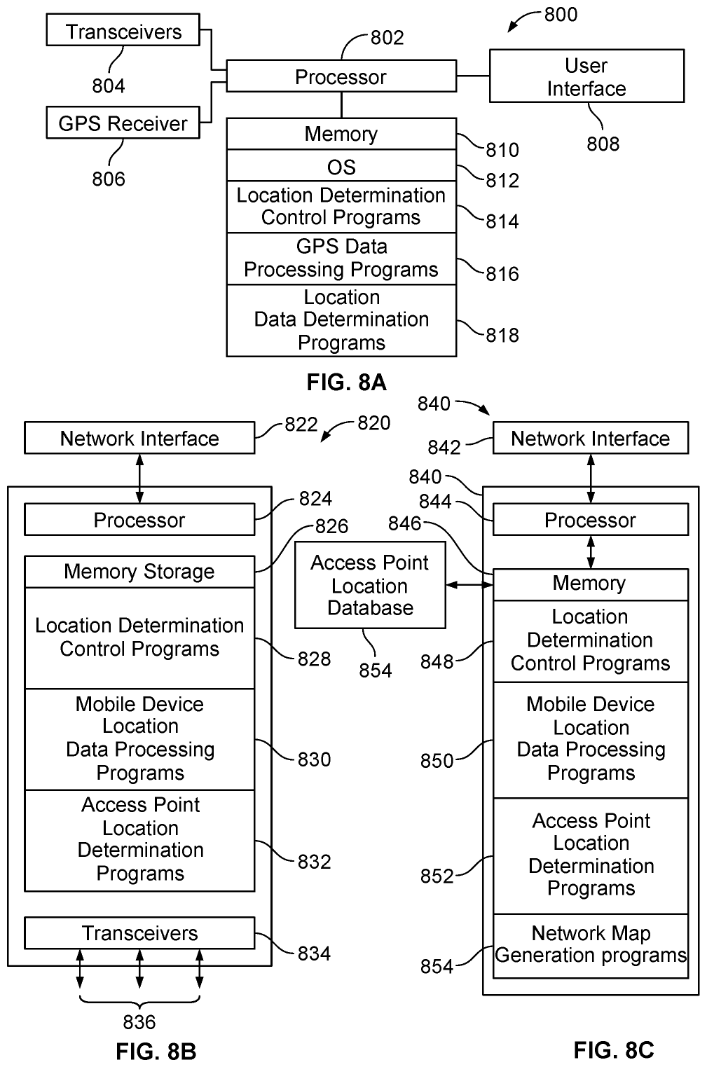

FIG. 8A is a simplified block diagram showing an example mobile device. Mobile device 800 represents an example implementation of any one of mobile devices 102-120 of FIG. 1. Mobile device 800 includes processor 802, user interface 808, transceivers 804, GPS receiver 806, and memory 810. Memory 810 includes code and program/instructions for a device operating system (OS) 812, location determination control programs 814, GPS data processing programs 816, and location data determination programs 818. Mobile device 800 may communicate with access points of a wireless network and/or a cellular network using transmitters and receivers implemented in transceivers 804. User interface 808 allows a user of mobile device 800 to provide control input to device 800. For example, in an implementation, a user may provide input at user interface 808 that enables or disables functions in mobile device 800 that provide location data to a wireless network. Processor 802 may comprise one or more processors, or other control circuitry or any combination of processors and control circuitry that provide overall control of mobile device 800 according to the disclosed embodiments. Memory 810 may be implemented as any type of as any type of computer readable storage media, including non-volatile and volatile memory.

In an example implementation, execution of location determination control programs 814, GPS data processing programs 816, and location data determination programs 818 by processor 802 causes mobile device 800 to operate according to the operations described for mobile device 120 in relation to FIG. 5.

FIG. 8B is a simplified block diagram showing an example access point. Access point 820 represents an example implementation of any one of access points AP1-AP4 of FIG. 1. Access point 820 includes processor 824, network interface 822, and memory 826 that includes code and program/instructions for location determination control programs 828, mobile device location data processing programs 830, and access point location determination programs 832. Access point 820 may connect to one or more networks and/or servers through network interface 822. Network interface 822 may be a wireless interface or any other type of interface. Transceivers 834 may comprise receivers and transmitter for communicating with mobile devices of a wireless network over uplinks/downlinks 836. Processor 824 may comprise one or more processors, or other control circuitry or any combination of processors and control circuitry that provide overall control of access point 820 according to the disclosed embodiments. Memory 826 may be implemented as any type of as any type of computer readable storage media, including non-volatile and volatile memory.

In an implementation, execution of location determination control programs 828, mobile device location data processing programs 830, and access point location determination programs 832 by processor 824 causes access point 820 to operate according to the operations described for access point AP3 in relation to FIG. 3.

FIG. 8C is a simplified block diagram showing an example server. Server 840 represents an example implementation of server 130 of FIG. 1. Server 840 includes processor 844, network interface 842, access point location database 854, and memory 846 that includes code and program/instructions for location determination control programs 848, mobile device location data processing programs 850, access point location determination programs 852, and network map generation programs 854. Server 130 may connect to the access points of one or more wireless networks through network interface 842. Network interface 842 may be a wireless interface or any other type of interface. Processor 844 may comprise one or more processors, or other control circuitry or any combination of processors and control circuitry that provide overall control of server 130 according to the disclosed embodiments. Memory 846 may be implemented as any type of as any type of computer readable storage media, including non-volatile and volatile memory.

In an implementation, execution of location determination control programs 848, mobile device location data processing programs 850, access point location determination programs 852, and network map generation programs 854 by processor 844 causes server 840 to operate according to the operations described for server 130 in relation to FIG. 7.

The example embodiments disclosed herein may be described in the general context of processor-executable code or instructions stored on memory that may comprise one or more computer readable storage media (e.g., tangible non-transitory computer-readable storage media such as memory 810, 826, or 846). As should be readily understood, the terms “computer-readable storage media” or “non-transitory computer-readable media” include the media for storing of data, code and program instructions, such as memory 810, 826, or 846, and do not include portions of the media for storing transitory propagated or modulated data communication multi-carrier signals.

While the functionality disclosed herein for mobile devices, access points, and servers has been described by illustrative example using descriptions of the various components and devices of implementations by referring to functional blocks and processors or processing units, controllers, and memory including instructions and code, the functions and processes of the implementations may be implemented and performed using any type of processor, circuit, circuitry or combinations of processors and/or circuitry and code. This may include, at least in part, one or more hardware logic components. For example, and without limitation, illustrative types of hardware logic components that can be used include field programmable gate arrays (FPGAs), application specific integrated circuits (ASICs), application specific standard products (ASSPs), system-on-a-chip systems (SOCs), complex programmable logic devices (CPLDs), etc. Use of the term processor or processing unit in this disclosure is mean to include all such implementations.

The disclosed implementations include an access point comprising a receiver, one or more processors coupled to the receiver, and memory in communication with the one or more processors. The memory comprises code executable by the one or more processors to control the access point to receive, at the receiver, a plurality of device locations and a plurality of quality indications from a plurality of mobile devices operating in a coverage area of the access point, wherein each one of the plurality of quality indications corresponds to one of the plurality of device locations, determine a set of device locations from the plurality of device locations based at least on the plurality of quality indications, and, determine a location of the access point based at least on the set of device locations. At least one of the plurality of device locations may comprises a positioning system location, and a corresponding one of the plurality of quality indications may comprise an indication of accuracy of the positioning system location. The indication of accuracy of the positioning system location may comprise data associated with signals used to determine the positioning system location. The indication of accuracy of the positioning system location may comprise a ranking of the accuracy of the positioning system location. The code may be further executable by the one or more processors to control the access point to update the location of the access point by repeating the receiving of the plurality of device locations and the plurality of quality indications, the determining of the set of device locations, and the determining of the location of the access point. The plurality of mobile devices may be configured to automatically send the plurality of device locations and the plurality of quality indications to the access point, and the code may be further executable by the one or more processors to control the access point to recognize the plurality of device locations and the plurality of quality indications received from the plurality of mobile devices as location data to be used in determining the location of the access point. The code may be further executable by the one or more processors to control the access point to send a request for a device location to each of the plurality of mobile devices.

The disclosed embodiments also include a server comprising one or more processors and memory in communication with the one or more processors, The memory comprises code executable by the one or more processors to control the server to receive a plurality of device locations from one or more mobile devices as each of the one or more mobile devices operates within the coverage area of one or more access points, associate one or more device locations of the plurality of device locations with each access point of the one or more access points, and, determine a location of each access point of the one or more access points based at least on each access point's associated one or more device locations. The code may be further executable by the one or more processors to control the server to receive a plurality of quality indications from the one or more mobile devices, wherein each one of the plurality quality indications corresponds to one of the plurality of device locations. The code may be further executable by the one or more processors to control the server to determine a location of each access point of the one or more access points based at least on each access point's associated one or more device locations by controlling the server to determine the location of each access point of the one or more access points based at least on a set selected from each access point's associated one or more device locations, wherein the set is selected based on one or more quality indications of the plurality of quality indications. At least one of the plurality of device locations may comprise a positioning system location, and a corresponding one of the plurality of quality indications may comprise an indication of accuracy of the positioning system location. The code may be further executable by the one or more processors to control the server to generate a network map indicating the location of each access point of the one or more access points.

The disclosed embodiments further include a device comprising one or more processors and memory in communication with the one or more processors. The memory comprises code executable by the one or more processors to control the device to determine a device location, determine a quality indication, wherein the quality indication is associated with an accuracy of the device location, and send the device location and the quality indication to a network. The code may be further executable by the one or more processors to control the device to receive a request for location data from the network, and send the device location and the quality indication to the network in response to the request for location data. The code may be further executable by the one or more processors to control the device to determine that a trigger event has occurred, and send the device location and the quality indication to the network in response to the determination that the trigger event has occurred. The trigger event may comprise a timer generating a trigger signal. The code may be further executable by the one or more processors to control the device to determine that a trigger event has occurred by determining that the device location has been determined with an accuracy above a threshold level. The quality indication may comprise data associated with signals used to determine the device location. The quality indication may comprise a ranking of the accuracy of the device location.

Although the subject matter has been described in language specific to networks/systems, structural features and/or methodological acts, it is to be understood that the subject matter defined in the appended claims is not necessarily limited to the specific features or acts described above. Rather, the specific features and acts described above are disclosed as example embodiments, implementations, and forms of implementing the claims and these example configurations and arrangements may be changed significantly without departing from the scope of the present disclosure. Moreover, although the example embodiments have been illustrated with reference to particular elements and operations that facilitate the processes, these elements, and operations may be combined with or, be replaced by, any suitable devices, components, architecture or process that achieves the intended functionality of the embodiment. Numerous other changes, substitutions, variations, alterations, and modifications may be ascertained to one skilled in the art and it is intended that the present disclosure encompass all such changes, substitutions, variations, alterations, and modifications as falling within the scope of the appended claims.

What is claimed is:

1. A server comprising:
a processor; and
a computer-readable medium storing executable instructions for causing the processor to perform operations comprising:
receiving device location information and signal strength information from a plurality of mobile devices, the device location information indicating a location of a respective one of the plurality of mobile devices, the signal strength information including information indicative of a strength of one or more signals from one or more access points measured by the respective one of the plurality of mobile devices at the location indicated in the device location information;
associating the device location information and the signal strength information received from the plurality of mobile devices with a respective one of the one or more access points; and
determining a location of the one or more access points of the network based at least on the device location information and signal strength information.

2. The server of claim 1, wherein the signal strength information includes an identifier of a respective one of the plurality of access points associated with the signal information indicative of the strength of the one or more signals; and wherein associating the device location information and signal strength information with the one or more access points includes comparing the identifier of the respective one of the plurality of access points to network information.

3. The server of claim 1, wherein the computer-readable medium further includes instructions for causing the processor to perform operations comprising:
sending a request to the plurality of mobile devices for the device location information and the signal strength information.

4. The server of claim 1, wherein the computer-readable medium further includes instructions for causing the processor to perform operations comprising:
generating network map information including the locations of the one or more access points.

5. The server of claim 4, wherein the computer-readable medium further includes instructions for causing the processor to perform operations comprising:
redetermining a location of the one or more access points based on additional device location information and signal strength information; and
updating the network map information based on the redetermined location of the one or more access points.

6. The server of claim 4, wherein the device location information comprises a quality indication associated with the location of the respective one of the plurality of mobile devices, and wherein the computer-readable medium further includes instructions for causing the processor to perform operations comprising:
determining a quality indication associated with the location of a respective one of the plurality of access points based on the quality indications associated with the device location information used to determine the location of the respective one of the plurality of access points.

7. The server of claim 6, wherein the computer-readable medium further includes instructions for causing the processor to perform operations comprising:
updating the network map information to include the quality indication associated with the location of the respective one of the plurality of access points.

8. A method, executed by a data processing system for determining locations of one or more access points, comprising:
receiving device location information and signal strength information from a plurality of mobile devices, the device location information indicating a location of a respective one of the plurality of mobile devices, the signal strength information including information indicative of a strength of one or more signals from the one or more access points measured by the respective one of the plurality of mobile devices at the location indicated in the device location information;
associating via a processor the device location information and the signal strength information received from the plurality of mobile devices with a respective one of the one or more access points; and
determining via the processor a location of the one or more access points of the network based at least on the device location information and signal strength information.

9. The method of claim 8, wherein the signal strength information includes an identifier of a respective one of the plurality of access points associated with the information indicative of the strength of the one or more signals, and wherein associating the device location information and signal strength information with the one or more access points includes comparing the identifier of the respective one of the plurality of access points to network information.

10. The method of claim 8, further comprising:
sending a request to the plurality of mobile devices for the device location information and the signal strength information.

11. The method of claim 8, further comprising:
generating a network map of the locations of the one or more access points.

12. The method of claim 11, further comprising:
redetermining a location of the one or more access points based on additional device location information and signal strength information; and
updating the network map based on the redetermined location of the one or more access points.

13. The method of claim 11, wherein the device location information comprises a quality indication associated with the location of the respective one of the plurality of mobile devices, and the method further comprising:
determining a quality indication associated with the location of a respective one of the plurality of access points based on the quality indications associated with the device location information used to determine the location of the respective one of the plurality of access points.

14. The method of claim 13, further comprising:
updating the network map to include the quality indication associated with the location of the respective one of the plurality of access points.

15. A memory device storing instructions that, when executed on a processor of a computing device, cause the computing device to determine locations of access points, by:
receiving device location information and signal strength information from a plurality of mobile devices, the device location information indicating a location of a respective one of the plurality of mobile devices, the signal strength information including information indicative of a strength of one or more signals from the one or more access points measured by the respective one of the plurality of mobile devices at the location indicated in the device location information;
associating the device location information and the signal strength information received from the plurality of mobile devices with a respective one of the one or more access points; and
determining a location of the one or more access points of the network based at least on the device location information and signal strength information.

16. The memory device of claim 15, wherein the signal strength information includes an identifier of a respective one of the plurality of access points associated with the information indicative of the strength of the one or more signals, and wherein associating the device location information and signal strength information with the one or more access points includes comparing the identifier of the respective one of the plurality of access points to network information.

17. The memory device of claim 15, wherein the computer-readable medium further includes instructions for causing the processor to perform operations comprising:
sending a request to the plurality of mobile devices for the device location information and the signal strength information.

18. The memory device of claim 15, wherein the computer-readable medium further includes instructions for causing the processor to perform operations comprising:
generating a network map of the locations of the one or more access points.

19. The memory device of claim 18, wherein the computer-readable medium further includes instructions for causing the processor to perform operations comprising:
redetermining a location of the one or more access points based on additional device location information and signal strength information; and
updating the network map based on the redetermined location of the one or more access points.

20. The memory device of claim 18, wherein the device location information comprises a quality indication associated with the location of the respective one of the plurality of mobile devices, and wherein the computer-readable medium further includes instructions for causing the processor to perform operations comprising:
determining a quality indication associated with the location of a respective one of the plurality of access points based on the quality indications associated with the device location information used to determine the location of the respective one of the plurality of access points.
